(19) United States
(12) Patent Application Publication
(10) Pub. No.: US 2009/0307679 A1
(43) Pub. Date: Dec. 10, 2009

(54) COMMUNICATION DEVICE AND A HOST DEVICE, A METHOD OF PROCESSING SIGNAL IN THE COMMUNICATION DEVICE AND THE HOST DEVICE, AND A SYSTEM HAVING THE COMMUNICATION DEVICE AND THE HOST DEVICE

(75) Inventors: Uee Song LEE, Seoul (KR); Won-Bin Jang, Seoul (KR); Jong Pil Won, Seoul (KR); Jung Su Lee, Seoul (KR); Ju Ho Ha, Seoul (KR); Kyung Hwan Kim, Suwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/343,186

(22) Filed: Dec. 23, 2008

(30) Foreign Application Priority Data
Jun. 10, 2008 (KR) 10-2008-0054340
Jul. 28, 2008 (KR) 10-2008-0073683

(51) Int. Cl. G06F 9/44

(52) U.S. Cl. 717/168

(57) ABSTRACT

A method of communicating between a mobile terminal and a personal computer. The method includes communicating between the personal computer and the mobile terminal using a first communication mode, transmitting an executable program from the mobile terminal to the personal computer, the executable program configured to be executed on the personal computer and to display on the personal computer at least one copy widget program respectively corresponding to at least one original widget program executing on the mobile terminal, receiving on the mobile terminal from the personal computer a modification control signal corresponding to a modification of the at least one copy widget program displayed on the personal computer, and modifying the at least one original widget program on the mobile terminal with modifications made to the at least one copy widget program displayed on the personal computer.

This application claims the benefit of Korean Patent Applications No. 10-2008-0054340, filed on Jun. 10, 2008, and 10-2008-0073683, filed on Jul. 28, 2008, which are hereby incorporated by reference in their entirety.

### BACKGROUND OF THE INVENTION

1. Field of the Invention

The present application relates to a communication device and corresponding method for transferring widget applications between a mobile terminal and a host device.

2. Discussion of the Related Art

Mobile terminals now provide many additional services beside the basic call service. For example, user's can now access the Internet, play games, watch videos, listen to music, capture images and videos, record audio files, etc. Mobile terminals also now provide broadcasting programs such that user can watch television shows, sporting programs, videos etc.

Thus, mobile terminals include graphical user interfaces (Guls) allowing the user to traverse through the various functions provided on the terminal. However, the mobile terminal is small in size and thus it is difficult for the user to manage or change functions included on the terminal.

### SUMMARY OF THE INVENTION

Accordingly, one object of the present invention is to address the above-noted and other drawbacks.

Another object of the present application is to efficiently manage and change widgets services on the mobile terminal.

Another object of the present application is to manage widgets services on a mobile terminal by using a host device such as a personal computer connected to the mobile terminal.

To achieve these and other advantages and in accordance with the purpose of the present invention, as embodied and broadly described herein, the present invention provides in one aspect a mobile terminal including an interface module configured to connect the mobile terminal to a personal computer, a communication unit configured to communicate with the personal computer via a first communication mode, and a controller configured to transmit an executable program to the personal computer via the interface module, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal. Further, the communication unit is further configured to receive a modification control signal corresponding to a modification of the at least one copy widget program displayed on the personal computer, and the controller is further configured to modify the at least one original widget program on the mobile terminal with modifications made to the at least one copy widget program displayed on the personal computer.

In another aspect, the present invention provides a personal computer including an interface module configured to connect the personal computer to a mobile terminal, a communication unit configured to communicate with the mobile terminal via a first communication mode, and a controller configured to receive an executable program from the mobile terminal via the interface module, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal. Further, the communication unit is further configured to transmit a modification control signal corresponding to a modification of the at least one copy widget program displayed on the personal computer such that the at least one original widget program on the mobile terminal is modified with modifications made to the at least one copy widget program displayed on the personal computer.

In yet another aspect, the present invention provides a method of communicating between a mobile terminal and a personal computer. The method includes connecting the mobile terminal to the personal computer, communicating between the personal computer and the mobile terminal using a first communication mode, transmitting an executable program from the mobile terminal to the personal computer, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal, receiving on the mobile terminal from the personal computer a modification control signal corresponding to a modification of the at least one copy widget program displayed on the personal computer, and modifying the at least one original widget program on the mobile terminal with modifications made to the at least one copy widget program displayed on the personal computer.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the embodiments and are incorporated in and constitute a part of this application, illustrate embodiment(s) of the embodiments and together with the description serve to explain the principle of the embodiments. In the drawings:

FIG. 1 is an overview illustrating a mobile terminal connected to and communication with a host device according to a first embodiment of the present application;

FIG. 2 is a process flow diagram illustrating operations of the mobile terminal and the host device according to the first embodiment of the present application;

FIG. 3 is an overview illustrating operations of a mobile terminal and a host device according to a second embodiment of the present application;

FIG. 4 is an example of a Universal Serial Bus (USB) class table used in the second embodiment of the present application;

FIG. 5 is a process flow diagram illustrating operations of the mobile terminal and the host device according to the second embodiment of the present application;

FIG. 6 is an overview of a Small Computer System Interface (SCSI) command format according to the second embodiment of the present application;

FIG. 7 is a table illustrating examples of SCSI commands according to the second embodiment of the present application;

FIG. 8 is a software hierarchy of the mobile terminal according to the second embodiment of the present application;

FIG. 9 is a block diagram of a mobile terminal and a host device according to a third embodiment of the present application;

FIG. 10 is a block diagram illustrating a detailed configuration of the mobile terminal according to the third embodiment of the present application;

FIG. 11 is a flow chart illustrating operations of a host device according to a fourth embodiment of the present application;

FIG. 12 is a flow chart illustrating operations of a mobile terminal and a host device according to a fifth embodiment of the present application;

FIG. 13 is a block diagram illustrating the mobile terminal and the host device according to the fifth embodiment of the present application; and

FIG. 14 is a flow chart illustrating operations of a mobile terminal and a host device according to a sixth embodiment of the present application.

### DETAILED DESCRIPTION OF THE INVENTION

Reference will now be made in detail to the preferred embodiments of the present invention, examples of which are illustrated in the accompanying drawings.

Many functions on the mobile terminal include widgets or widget services that operate as secondary functions on the terminal. For example, widget services include phone banking, multimedia playback, real-time weather information time, scheduling information, games, a phonebook, etc. The user can then select a particular widget service on the mobile terminal to perform the desired service.

However, because the mobile terminal has a small display, it is difficult for the user to manage, change, update, etc. a widget service or multiple widget services. According to an embodiment of the present application, the widget services are copied from the mobile to a host device such as a personal computer. The user can then use the larger size display provided with the personal computer to change or modify a widget service, which is then copied back to the mobile terminal. Therefore, the user can easily manage the widget services on their mobile terminal.

In more detail, the mobile terminal can be connected to the personal computer via a communication port such as a USB port, IEEE 1394 port, and via the wireless Bluetooth standards. The following description refers to the mobile terminal being connected to the host device via the USB port and cable, but the present application also refers to the other types of connections.

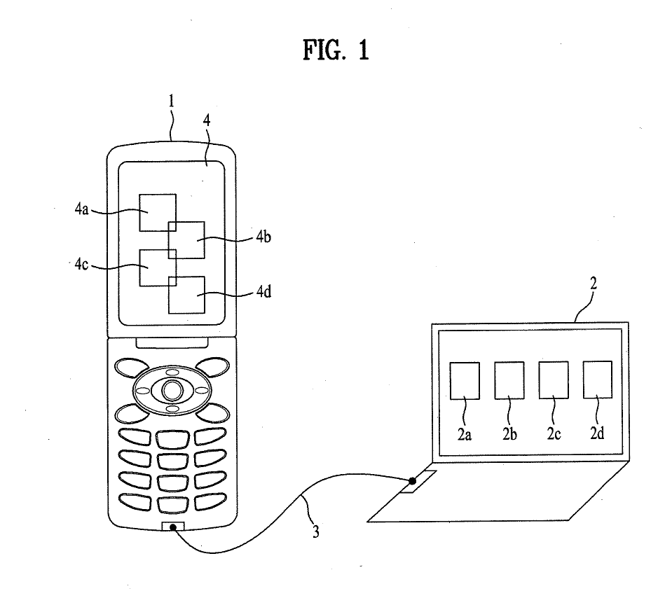

FIG. 1 is an overview illustrating a mobile terminal 1 and a host device 2 according to a first embodiment of the present application. The host device 2 in this example is a laptop computer. However, the host device 2 can be a desktop computer or other type of computer. As shown in FIG. 1, the mobile terminal 1 and the host device 2 can be connected through a USB cable 3. Thus, the mobile terminal 1 and the host device 2 communicate with each other using the USB communication standard in this example. However, as discussed above, the mobile terminal and the host device 2 can be connected via the Bluetooth communication standard, IEEE 1394 standard, etc.

Further, in FIG. 1, the mobile terminal 1 is executing or running four widgets 4a, 4b, 4c and 4d on the display 4 that the user has selected. In addition, as shown, the host device displays the same corresponding widgets 5a, 5b, 5c and 5d on a display 5. In the following description, the widgets 4a, 4b, 4c and 4d on the mobile terminal 1 are referred to as “original widgets” and the widgets 5a, 5b, 5c and 5d on the host device 2 are referred to as “copy widgets”. Also, the host device 2 can display the copy widgets 5a, 5b, 5c and 5d in the same or different configuration as the original widgets 4a, 4b, 4c and 4d.

Therefore, as shown in FIG. 1, the user can better see and manage the widgets on the host device 2, because the host device 2 has a larger screen. Thus, because the host device 2 includes a large screen compared to that of the mobile terminal 1, the host device 2 can simultaneously display all widgets operable on the mobile terminal 1 in an arrangement in which it is easy for the user to manage the widgets.

Further, a specific rule can be applied to the arrangement of the copy widgets on the screen to increase the user's convenience. For example, a copy widget that is often used can be displayed in an enlarged shape or can be located near the center of the screen. In addition, the copy widgets can be displayed at positions specified by the user or be arranged on the screen of the host device 2 at the same positions as those of the original widgets arranged on the screen of the mobile terminal 1. The user can also change the positions of the copy widgets arranged on the display screen using a touch and drag operation, using a pointing device such as a mouse, etc. Further, a process for checking the arrangement rule for arranging the copy widgets can then be executed on the host device 2 so as to display the copy widgets according to the arrangement rule.

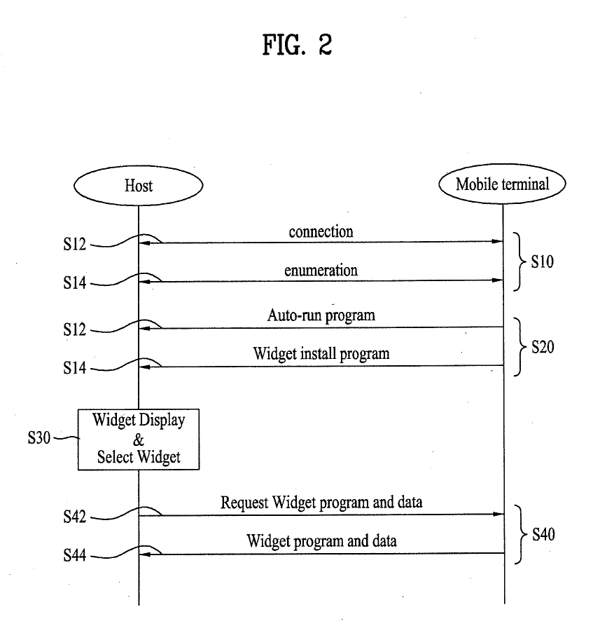

Next, FIG. 2 is a process flow diagram illustrating operations of the mobile terminal 1 and the host device 2 according to the first embodiment of the present application. As shown, when the mobile terminal 1 and the host device 2 are connected (S12), the mobile terminal 1 and the host device 2 perform a process for recognizing each other (S14). This process is referred to as an “enumeration” process. When the enumeration process has completed, the mobile terminal 1 and the host device 2 can communicate with each other (S10).

Then, the mobile terminal 1 transmits an auto-run program (S22) and a widget install program (S24) to the host device 2 (S20). The auto-run program is one of a variety of programs stored in the mobile terminal 1 and is automatically executed by the host device 2 when the mobile terminal 1 is connected to the host device 2. That is, via the auto-run program, the host device 2 receives a basic program for controlling the mobile terminal 1 connected to the host device 2.

In addition, the widget install program is one of the variety of programs stored in the mobile terminal 1 and includes, for example, a function to enable the host device 2 to generate the copy widgets, display the copy widgets, modify the copy widgets and transmit information corresponding to the modified copy widgets to the mobile terminal 1 such that the original widgets are modified in the same manner as the copy widgets. Further, although the widget install program is provided separately from the auto-run program in the above description of the present application (S22 and S24), the auto-run program and the widget install program can be combined and transmitted as a single program.

In addition, as shown in FIG. 2, the host device 2 generates and displays the copy widgets using the widget install program transmitted from the mobile terminal 1 (S30). Also, in step S30, the user can select one or more of the displayed copied widgets. When the user selects a specific widget or widgets, the host device 2 requests that the mobile terminal 1 transmit widget information associated with the selected widget such as a widget program for implementing a widget service corresponding to the selected widget and widget data associated with the corresponding widget service stored in the mobile terminal 1 (S42).

The mobile terminal 1 then transmits the corresponding widget program and data stored in the mobile terminal to the host device 2 (S44). The host device 2 can display and execute the selected widget on the screen of the display 5 of the host device 2 based on the data received from the mobile terminal 1. The steps S42 and S44 are also illustrated by step S40 in FIG. 2

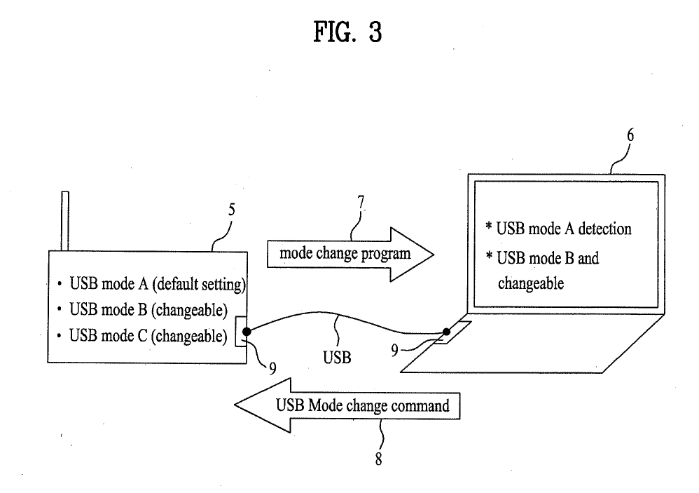

Next, FIGS. 3 to 8 illustrate a second embodiment of the present application. The second embodiment is a more detailed version of the first embodiment and provides a method in which a host device remotely changes a communication mode of a mobile terminal when a widget service is executed.

In more detail, FIG. 3 is an overview illustrating operations of a mobile terminal 6 and a host device 7 according to the second embodiment of the present application. Further, the second embodiment refers to the mobile terminal 6 and the host device 7 including a USB module 9. Thus, the mobile terminal 6 and the host device 7 can be connected together using a USB cable.

Further, in this example, the mobile terminal 6 supports three USB modes (e.g., USB modes A, B and C) and the USB mode A is set as a default mode in the mobile terminal 6. Thus, when the mobile terminal 6 is connected to the host device 7 using the USB modules 9 and the USB cable, the host device 7 detects the USB mode A in the mobile terminal 6 and operates according to the USB mode A.

Further, as shown in FIG. 3, when the mobile terminal 6 is connected to the host device 7, the mobile terminal 6 transmits a software mode change program 8a associated with a USB mode change to the host device 7. The program is then loaded or installed in the host device 7. Thereafter, the host device 7 transmits a USB mode change command 8b to the mobile terminal 6. The mode change program 8b can be transmitted automatically or based on a user's selection.

Then, when the mobile terminal 6 receives the command, the mobile terminal 6 changes the operating mode to another USB mode identified in the mode change command 8b (in this example, the USB mode is changed from mode A to mode B). For example, the variety of USB modes includes a data storage mode and a data communication mode. Further, when the mobile terminal 6 is connected to the host 7, the host 7 generally sees the mobile terminal 6 as a storage device (data storage mode). According to this embodiment, the USB mode A is the data storage mode and the USB mode B is the data communication mode. Thus, the host 7 requests the mobile terminal 6 change its USB mode to the USB mode B to thereby transmit and modify particular widgets operable on the mobile terminal 6.

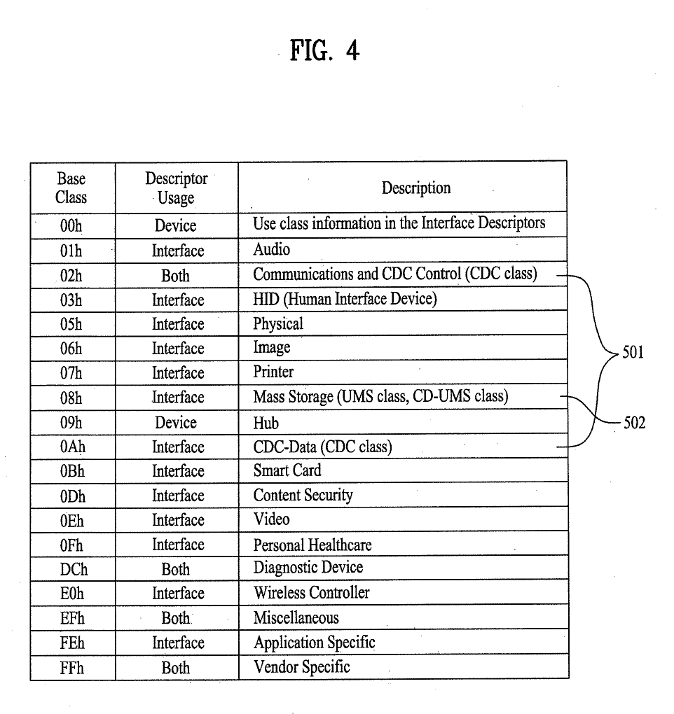

Next, FIG. 4 is a table illustrating a variety of USB modes supported by the USB standard. As shown, a variety of classes are defined in the USB standard. The variety of classes are also associated with the USB modes. For example, the classes of “02h” and “0Ah” identified by the reference numeral 501 are associated with a data communication mode (e.g., the CDC USB mode), and the class of “08h” identified by the reference numeral 502 is associated with a data storage mode (e.g., the CDROM USB mode).

Therefore, the USB standard includes different USB classes according to a variety of purposes of the USB device. Further, a USB device having a specific purpose has an activated USB class for the specific purpose and a USB host that controls the USB device activates a USB class corresponding to the USB class of the USB device to perform data communication according to the USB standard. In the above description, the USB host 7 communicates with the mobile terminal 6 using the USB mode A when the mobile terminal is first connected to the host 7.

Therefore, because the functions of the USB host and the USB device are determined according to selection of the USB class, the selection of the USB class corresponds to the selection of the USB operating mode. In addition, an application can use or operate in association with all or part of a plurality of USB classes required for the corresponding function. For example, an USB modem application uses the classes “02h” and “0Ah”, and a USB storage device application uses the class “08h” shown in FIG. 4.

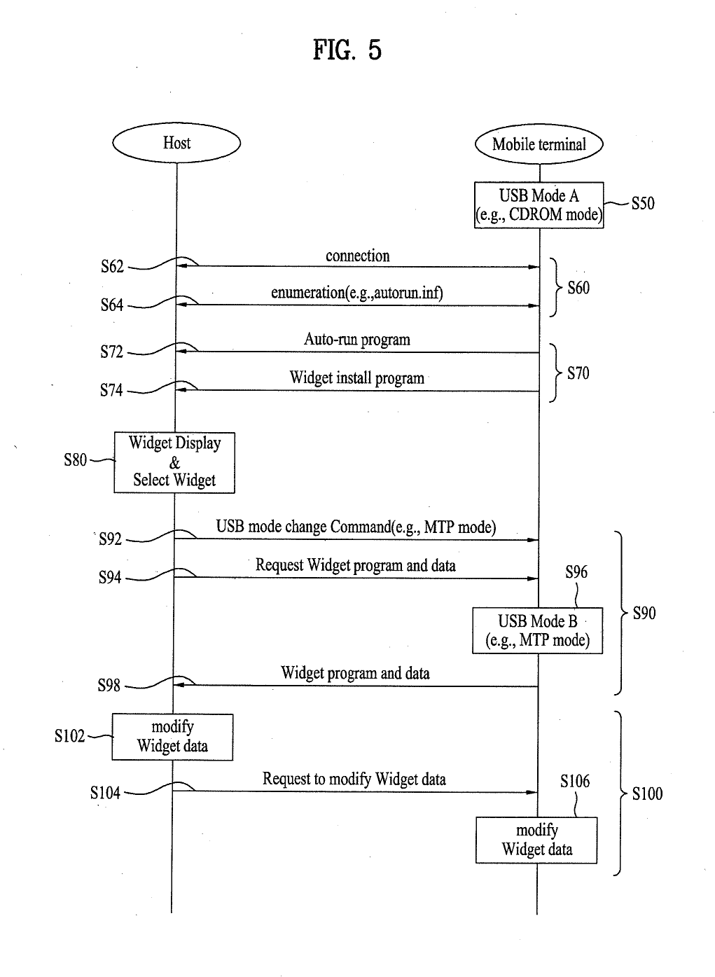

Next, FIG. 5 is a process flow diagram illustrating operations of the mobile terminal 6 and the host device 7 according to the second embodiment. This embodiment assumes the USB mode of the mobile terminal 6 has been initially set to a “CDROM mode” which operates as a data storage medium (S50). Then, when the mobile terminal 6 is connected to the host device 7 (S62), the host device 7 is subjected to an “enumeration” process for recognizing the mobile terminal 6 (S64).

When the enumeration process has been completed, the host device 7 confirms the mode of the mobile terminal 6 as the “CDROM mode” and the mobile terminal 6 and host device 7 are able communicate data with each other (S60). Then, the mobile terminal 6 transmits an auto-run program (S72), a widget install program, and a USB mode change program to the host device 7 (S74). Steps S72 and S74 are also illustrated by step S70 in FIG. 5.

Further, as discussed above, the auto-run program is one of a variety of programs stored in the mobile terminal 6 and is automatically executed by the host device 7 when the mobile terminal 6 is connected to the host device 7. That is, through the auto-run program, the host device 7 receives a basic program for controlling the mobile terminal 6 connected to the host device 7 (S72). In one example, an auto-run file “autorun.inf” used in a CDROM USB mode can be used as the auto-run program.

In addition, the widget install program is one of the variety of programs stored in the mobile terminal 6 and includes a function for enabling the host device 7 to generate and modify the copy widgets and also to modify the original widgets based on the modifications made to the copy widgets. The USB mode change program also changes the USB mode of the mobile terminal 6.

Also, in this embodiment, the CDROM USB mode is assumed to comply with the Small Computer System Interface (SCSI) standard. In more detail, the SCSI is a standard serial interface for connection of peripheral devices to a computer, and includes mechanical and electrical requirements for connection of input/output buses and includes a set of commands for peripheral devices. Thus, in this embodiment, the mobile terminal 6 and the host device 7 are connected to each other through a USB module and corresponding USB cable, and the mobile terminal 6 transmits a SCSI program according to the SCSI standard contained in the mobile terminal 6 as the USB mode change program to the host device 7 (S74).

Although the widget install program and the USB mode change program (e.g., the SCSI program) are provided separately in addition to the auto-run program in steps S72 and S74 (i.e., step S70), the auto-run program, the widget install program, and the USB mode change program can be included in a single program and transmitted as a single program in a single step.

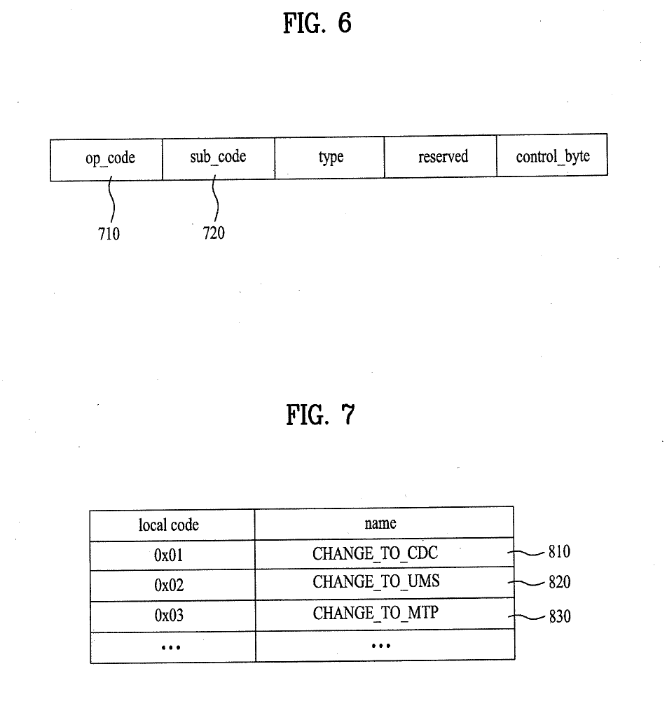

Then, the host device 7 generates copy widgets using the widget install program transmitted from the mobile terminal 6 and displays the copy widgets (S80). The user can also select one or more of the displayed copy widgets. When the user selects a specific widget, the host device 7 remotely changes the USB mode of the mobile terminal 6 (S92). That is, the host device 7 transmits a USB mode change command to the mobile terminal 6 using the USB mode change program (e.g., the SCSI program) described above. The USB mode change command also complies with the SCSI standard, which will be described later in more detail with reference to FIGS. 6 and 7.

Then, the host device 7 requests that the mobile terminal 6 transmits widget information associated with the selected widget (e.g., a widget program for implementing a widget service corresponding to the selected widget and widget data associated with the corresponding widget service stored in the mobile terminal 6) (S94).

Further, the second embodiment refers to the USB mode being changed from a CDROM mode to an Multimedia Transmission protocol (MTP) mode. That is, the MTP mode is a type of application for efficiently transmitting a variety of multimedia data. Therefore, when the specific widget service that the user has selected in step S80 is a multimedia widget associated with multimedia playback/transmission, the host device 7 changes the USB mode of the mobile terminal 6 to the MTP mode in order to implement the selected multimedia widget.

Then, upon receiving the USB mode change command, the host device 7 resets the USB mode to the requested USB mode (e.g., the MTP mode) (S96). Further, at step S96, the mobile terminal 6 may itself load a program of the requested USB mode or the host device 7 may remotely change the USB mode of the mobile terminal 6. Thereafter, the mobile terminal 6 transmits the widget program and widget data requested by the host device 7 under the changed USB mode (e.g., the MTP mode) (S98). Steps S92-S98 are also referred to as step S90 in FIG. 5.

Then, after step S90, the host device 7 receives the widget program and widget data associated with the selected widget from the mobile terminal 6 and generates and displays copy widgets. The user can then modify or add copy widget data through the display screen of the host device 7 (S102). Next, the host device 7 transmits the modified copy widget data to the mobile terminal 6, and the mobile terminal 6 updates the original widgets stored in the mobile terminal 6 with the received copy widget data (S106). The steps S102-106 are also referred to a widget data modification step S90 in FIG. 5.

Next, FIGS. 6 and 7 illustrate a mode change command format in the SCSI standard according to the second embodiment of the present application. In more detail, a SCSI command is used to control a large-capacity auxiliary storage device such as a hard disk, a CD, or a DVD. For the USB standard, the USB mode (e.g., the UMS or CD-UMS class “08h” in FIG. 4) corresponding to a large-capacity storage device supports the SCSI command.

Further, as shown in FIG. 6, according to the SCSI standard, the SCSI command includes an op_code 710 and a sub_code 720. Thus, according to embodiments of the present application, the variety of SCSI commands described above is defined in the op_code 710 and the sub_code 720. Also, the USB mode change command 8a associated with the second embodiment of the present application is preferably defined in the op_code 710 and the sub_code 720. However, the USB mode change command 8a can be defined in another region of the SCSI command format. For example, according to the SCSI standard, some regions (e.g., regions of 60h to FFh) in the op_code 710 are set as reserved regions that can be arbitrarily used by manufacturers. Accordingly, when the USB mode change command 8a is transmitted using the regions 60h to FFh in the op_code 710, each manufacturer can easily define and use the USB mode change command 8a while maintaining compatibility with the existing SCSI standard.

In addition, the SCSI standard reserves some regions of the SCSI command for device manufacturers. Therefore, one embodiment of the present application uses the reserved regions to instruct the mobile terminal 6 to change the USB class activated in the mobile terminal 6. This allows the host 7 to remotely change the operating mode of the mobile terminal 6. Further, the mobile terminal 6 according to embodiments of the present application is able to operate in two or more USB operating modes and able to be set to an operating mode supporting the SCSI command. The host 7 can then transmit a specific SCSI command, which uses a reserved region defined in the SCSI standard, to the mobile terminal 6.

FIG. 7 is a table illustrating examples of the USB mode change command according to an embodiment of the present application. As shown, the table includes three specific SCSI commands 810, 820 and 830 used to change the USB mode of the USB device 6. For example, when the USB host 7 decides to change the operating mode of the mobile terminal 6 to a multimedia mode according to a result of the execution of a specific program (for example, the CD autorun.inf file) or according to user input, the host 7 transmits the CHANGE_TO_MTP command 830 shown in FIG. 7 to the mobile terminal 6. Upon receiving the CHANGE_TO_MTP command 810, the mobile terminal 6 loads an application which uses a multimedia playback/transmission function.

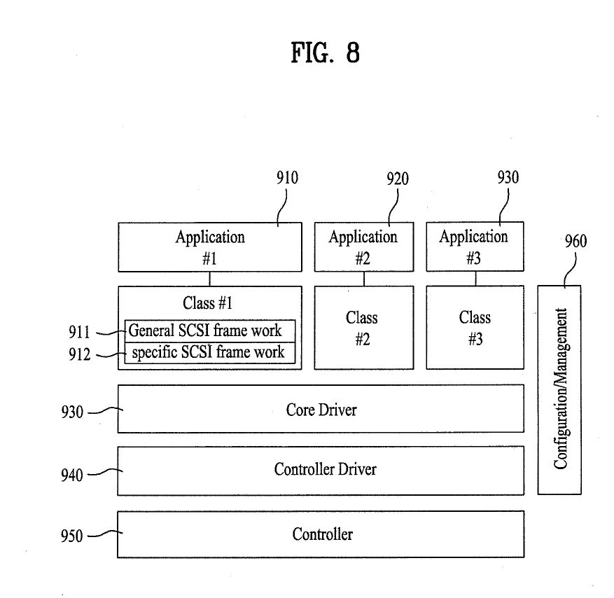

Next, FIG. 8 is an overview illustrating a USB hierarchy implemented in a USB device according to the second embodiment of the present application. As shown, a USB class layer is defined above a USB core driver layer 930. Further, application layers 910, 920 and 930 using respective USB classes are defined above the respective USB class layers. In addition, for a USB class supporting a large-capacity storage device such as a UMS or a CD-UMS, a corresponding USB class layer includes a general SCSI framework 911 for performing the appropriate SCSI command. Also, a specific SCSI framework 912 for performing the appropriate SCSI command is also included in the class layer. The specific framework 912 can also be included in the application layer 910, 920 or 930.

In addition, with reference to the USB hierarchy model, the SCSI command received from an external USB host is input to the general SCSI framework 911. The general SCSI framework 911 then performs a corresponding process if the received SCSI command is a general SCSI command or transfers the received SCSI command to the specific SCSI framework 912 if the received SCSI command is not a general SCSI command. Further, if the SCSI command received by the specific SCSI framework 912 is a specific SCSI command specified by a manufacturer, the specific SCSI framework 912 performs a process that the manufacturer has defined for the command. A controller driver layer 940, controller layer 950 and configuration/management layer 960 are also provided.

Then, upon receiving the specific SCSI command instructing the corresponding USB class change, the specific SCSI framework 912 activates an operation for changing the activated USB class. In addition, the USB class change operation can be performed by an operating system of the USB device and/or by changing a corresponding application.

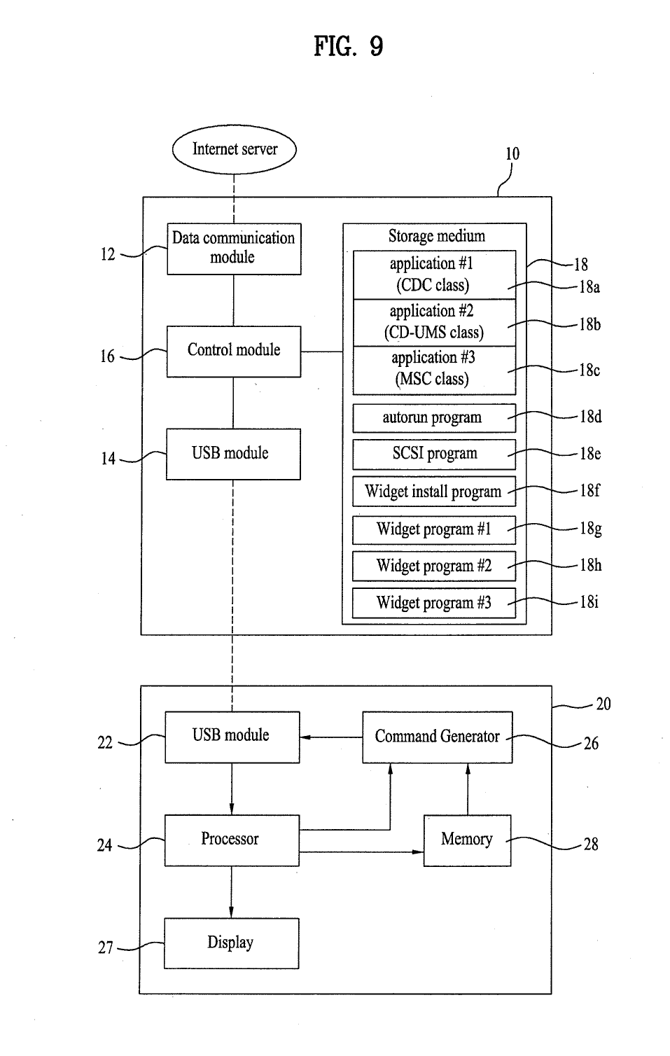

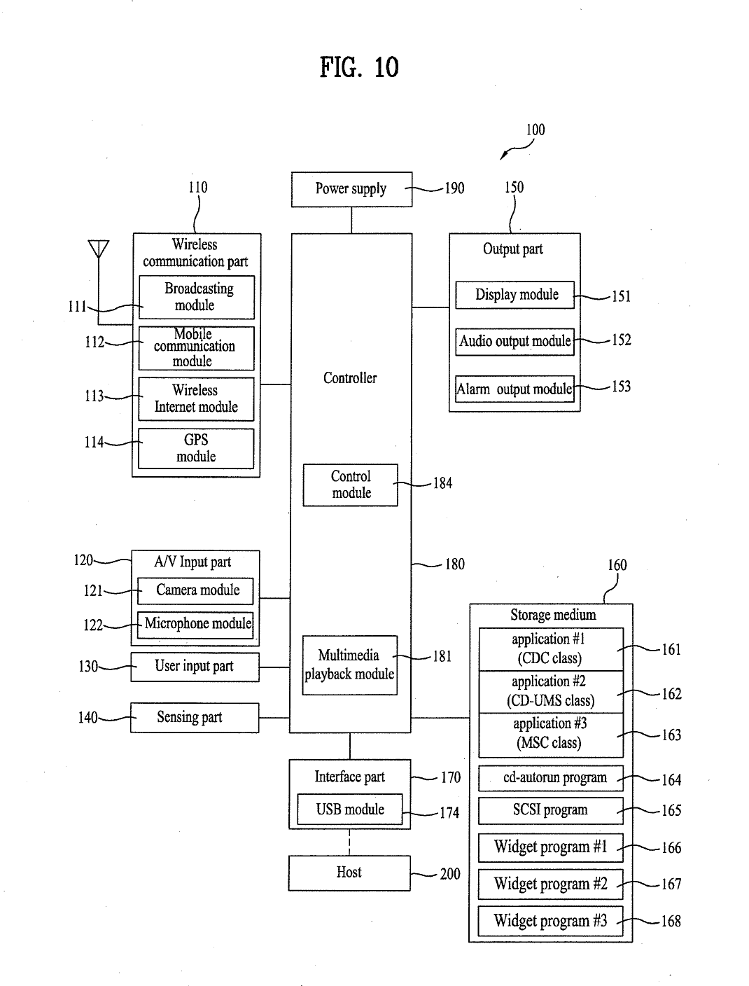

Next, FIG. 9 is a block diagram of a mobile terminal 10 and a host device 20 according to a third embodiment of the present application. As shown, the mobile terminal 10 includes a data communication module 12, a storage medium 18, a USB module 14 and a control module 16. Further, the data communication module 12 is connected to a wired or wireless communication network to perform data communication.

In addition, the storage medium 18 stores programs 18a, 18b and 18c supporting a plurality of USB classes, an auto-run program 18d, a SCSI program 18e, a widget install program 18f for loading a widget service in the host device 20, and at least one widget program supporting the widget service. The USB module 14 performs data communication with an external host device, and the control module 16 executes programs that use the USB classes.

In addition, the mobile terminal 10 transfers data received from the host device 20 through the USB module 14 to an external server or terminal computer connected to the communication network through the data communication module 12, and also transfers data received from the external server to the host device 20 through an opposite path. Also, as a small computing device, the mobile terminal 10 may include a central processing unit, a main memory and an auxiliary memory. The storage medium 18 may also include an auxiliary memory such as a flash memory or a disc medium.

Further, the mobile terminal 10 may form the USB hierarchy as shown in FIG. 8 using the storage medium 18 and may include a general/specific SCSI framework as a SCSI module for executing a general SCSI command and a specific SCSI command. The control module 16 also controls the overall operation of the mobile terminal 10 including the operation of each component thereof and may include a central processing unit and a main memory as hardware components.

In more detail, the control module 16 initially loads a program that uses the “CD-UMS” class that handles the mobile terminal 10 as a CD-ROM. When the control module 16 receives an instruction to change a class or a USB mode to a desired class from the host device 20, the control module 16 loads a program that uses the desired class. As discussed above, the auto-run program preferably has an autorun file format and/or name of CD-ROM and the SCSI program is a program that outputs the specific SCSI commands described above. The mobile terminal 10 also provides widget services to the user using widget programs stored in the storage medium 18.

In addition, as shown in FIG. 9, the host device 20 includes a USB module 22, a processor 24 and a memory 28. The USB module 22 performs data communication with the mobile terminal 10 connected to the host device 20. Further, the processor 24 processes data received from the mobile terminal 10 and controls the overall operations of the host device 20. In addition, the memory 28 temporarily or permanently stores relevant programs and data.

Also, the host device 20 include a command generator 26 that generates a command to request a widget program or generates a USB mode change command to change the USB mode of the mobile terminal 10. In addition, the processor 24 and the command generator 26 are shown separately, but the processor 24 may also function as the command generator 26.

Further, the host device 20 includes a display 27 that receives a widget service from the mobile terminal 10 and provides the widget service to the user. Then, if the user desires to directly change the USB mode of the mobile terminal 10, the host device 20 can provide currently applicable USB modes in the mobile terminal 10 to the user through the display 27. The user can then select a specific widget service or a specific USB mode based on information provided through the display 27. However, when the user has selected a specific widget service, the command generator 26 can automatically switch the mobile terminal 10 to a USB mode associated with the selected widget service without user intervention as described above.

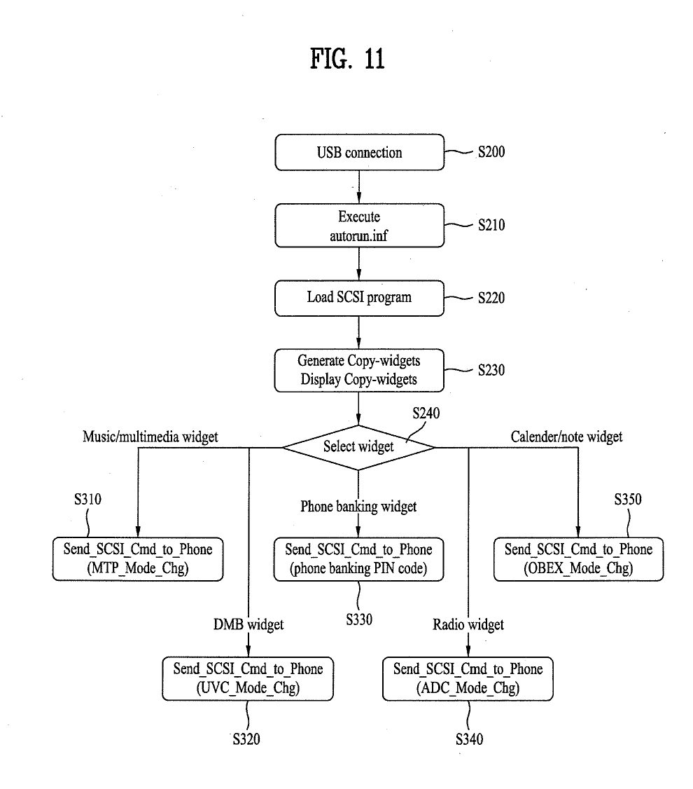

Next, FIG. 10 is a block diagram of a mobile terminal 100 according to a third embodiment of the present application. Further, the mobile terminal 100 may be a mobile phone, a smart phone, a notebook computer, a receiver for digital broadcasting data, a Personal Digital Assistant (PDA), a Portable Multimedia Player (PMP), a navigator, etc. The mobile terminal 100 can also be connected to a wireless communication network and to a Content Provider (CP) server that provides a variety of Internet services through the wireless communication network.

As shown in FIG. 10, the mobile terminal 100 includes a wireless communication part 110, an Audio/Video (AV) input part 120, a user input part 130, a sensing part 140, an output part 150, a storage medium 160, an interface part 170, a controller 180 and a power supply 190. The wireless communication part 110 includes a broadcasting module 111, a mobile communication module 112, a wireless Internet module 113 and a GPS module 114. Further, two or more components may be combined into a single component or one component may be divided into two or more components.

In addition, the broadcasting module 111 receives a broadcast signal and/or broadcast-related information from an external broadcast management server through a broadcast channel. The broadcast channel may include a satellite channel and a terrestrial channel, and the broadcast management server may be a server that generates and transmits a broadcast signal and/or broadcast-related information or a server that receives and transmits a previously generated broadcast signal and/or broadcast-related information to a terminal.

Also, the broadcast-related information may be information associated with a broadcast channel, a broadcast program or a broadcast service provider. The broadcast signal may not only include a TV broadcast signal, a radio broadcast signal, and a data broadcast signal, but may also include a broadcast signal that is a combination of a TV or radio broadcast signal with a data broadcast signal. Further, the broadcast-related information may also be provided through a mobile communication network. In this instance, the broadcast-related information can be received through the mobile communication module 112.

In addition, the broadcast-related information may be provided in a variety of forms. For example, the broadcast-related information may be provided in the form of a Digital Multimedia Broadcasting (DMB) Electronic Program Guide (EPG) or a Digital Video Broadcasting-Handheld (DVB-H) Electronic Service Guide (ESG). Also, the broadcasting module 111 receives broadcast signals using a variety of broadcast systems. In more detail, the broadcasting module 111 can receive digital broadcast signals using a digital broadcast system such as the Digital Multimedia Broadcasting-Terrestrial (DMB-T) system, the Digital Multimedia Broadcasting-Satellite (DMB-S) system, the Media Forward Link Only (MediaFLO) system, the Digital Video Broadcasting-Handheld (DVB-H) system, or the Integrated Services Digital Broadcasting-Terrestrial (ISDB-T) system. The broadcasting module 111 can also operate with other type of broadcast system that provides broadcast signals.

Further, a broadcast signal and/or broadcast-related information received through the broadcasting module 111 can be stored in the storage medium 160. The mobile communication module 112 transmits and receives a wireless signal with at least one of a base station, an external terminal, and a server over a mobile communication network. The wireless signal may include a voice call signal, a video call signal, or data in a variety of formats associated with transmission and reception of text/multimedia messages.

In addition, the wireless Internet module 113 is a module for wireless Internet connection and can be provided internally or externally. The GPS module 114 also receives navigation information from a plurality of satellites. Further, the A/V input part 120 is used to input an audio signal or a video signal and includes a camera module 121, a microphone module 122 and the like. Also, the camera module 121 processes an image frame of a still image or a moving image acquired through an image sensor in a video call mode or an image capture mode. The processed image frame can then be displayed on a display module 151.

Further, the image frame processed by the camera module 121 can also be stored in the storage medium 160 or be transmitted to the outside through the wireless communication part 110. The A/V input part 120 may also include two or more camera modules 121 depending on the configuration of the terminal. In addition, the microphone module 122 receives an external sound signal through a microphone and processes it into electrical audio data in a phone call mode or an audio recording mode, or a voice recognition mode. In the phone call mode, the processed audio data is converted into a format transmittable to a base station through the mobile communication module 112.

In addition, the microphone module 122 may use a variety of noise removal algorithms for removing noise occurring when receiving external sound signals. Also, the user input part 130 generates key input data corresponding to key strokes that the user has entered for controlling the operation of the terminal. In more detail, the user input part 130 may include a key pad, a dome switch, a resistive or capacitive touchpad, a jog wheel, a jog switch, or the like. In particular, when the touchpad is layered on the display part 151, touchpad can be referred to as a “touch screen”.

Further, the sensing part 140 detects the current state of the mobile terminal 100 such as an open/closed state of the mobile terminal 100, location of the mobile terminal 100, presence or absence of user contact with the mobile terminal 100 and generates a sensing signal for controlling the operation of the mobile terminal 100. For example, when the mobile terminal 100 is a slide mobile phone, the sensing part 140 can detect whether the slide phone has been opened or closed. The sensing part 140 also provides sensing functions associated with detection of whether or not the power supply part 190 supplies power or whether or not the interface part 170 has been coupled with an external device.

In addition, the interface part 170 serves as an interface with external devices connected to the mobile terminal 100. For example, the interface part 170 may include wired/wireless headset ports, external power charger ports, wired/wireless data ports, card sockets (for example, memory card or SIM/LIM card sockets), audio input/output (I/O) ports, video I/O ports, earphone ports, or the like. The interface part 170 also receives and transfers data or power from an external device to each component of the mobile terminal 100 or transmits internal data of the mobile terminal 100 to an external device.

Further, the output part 150 outputs an audio signal, a video signal or an alarm signal. As shown in FIG. 10, the output part 150 includes the display module 151, an audio output module 152 and an alarm output module 153. In addition, the display module 151 displays information processed in the mobile terminal 100. For example, when the mobile terminal 100 is in a phone call mode, the display module 151 displays a User Interface (UI) or a Graphical User Interface associated with a phone call. When the mobile terminal 100 is in a video call mode or an image capture mode, the display module 151 displays a captured or received image or a UI or GUI. In addition, when the display module 151 and the touchpad are layered on each other to form a touch screen as described above, the display module 151 may be used not only as an output device but also as an input device.

In addition, the display module 151 may include at least one of a Liquid Crystal Display (LCD), a Thin Film Transistor-LCD (TFT-LCD), an Organic Light Emitting Diode (OLED), a flexible display, and a three-dimensional (3D) display. The mobile terminal 100 may also include two or more display modules 151. For example, the mobile terminal 100 may include both an external display module and an internal display module.

Further, the audio output module 152 outputs audio data received from the wireless communication part 110 or stored in the storage medium 160 in a call signal reception mode, a phone call mode, an audio recording mode, a voice recognition mode, a broadcast reception mode, or the like. The audio output module 152 also outputs an audio signal (e.g., a call signal reception sound, a message reception sound, etc.) associated with a function performed by the mobile terminal 100.

In addition, the audio output module 152 may include a speaker, a buzzer, or the like. Also, the alarm output module 153 outputs a signal for notification of the occurrence of an event in the mobile terminal 100. For example, examples of events occurring in the mobile terminal 100 include reception of a call signal indicating a phone call request, reception of a message, input of a key signal, alarming of a preset time, etc.

The alarm output module 153 also outputs a signal for notifying the occurrence of an event in a format other than audio or video signals. That is, the alarm output module 153 can output such a notification signal in a vibrating manner. For example, when a call signal or a message is received, the alarm output module 153 causes a vibration to notify the user of the call signal or message reception. When a key signal is input, the alarm output module 153 can also cause a vibration as a feedback to the key signal input. Therefore, through such vibration, the user is notified of the event occurrence. A signal for notification of the occurrence of an event may also be output through the display module 151 or the audio output module 152.

In addition, the storage medium 160 can store a program for processing and controlling the functions of the controller 180 and also temporarily store input/output data (e.g., a phonebook, messages, still images, moving images, etc.). The storage medium 160 may include at least one of various types of storage media including a flash memory, a hard disk, a multimedia card, a card-type memory (e.g., SD or XD memory, etc), a RAM, and a ROM. Further, the mobile terminal 100 can also operate web storage that performs the same storage function as that of the storage medium 160 on the Internet.

Also, the controller 180 includes a control module 184 for controlling the overall operations of the mobile terminal 100. For example, the controller 180 performs control and processing associated with, for example, voice call, data communication, video call, etc. The controller 180 also includes a multimedia playback module 181 for multimedia playback. In addition, the multimedia playback module 181 may be constructed by hardware in the controller 180 and be constructed by software separately from the controller 180.

The controller 180 can also identify an action of an object (e.g., a finger of the user) touching directly or near the touch screen and change the size or region of a screen displayed on the touch screen. Further, the controller 180 can display a scrollbar or a mini map for controlling the size or region of the screen displayed on the touch screen. In addition, the power supply 190 receives external or internal power under control of the controller 180 and supplies power used for operation to each component.

Next, the method for implementing a widget service through the Mobile terminal 100 of FIG. 10 will be described. As shown in FIG. 10, the storage medium 160 stores programs 161, 162 and 163 for supporting a plurality of USB classes, an auto-run program 164, a SCSI program 165, a widget install program 166 for loading a widget service in the host device 200, and at least one widget programs 167, 168 and 169 supporting the widget service.

In addition, a USB module 174 is implemented as a part of the interface part 170 that supports the connection of the mobile terminal 100 to an external device. When the mobile terminal 100 is connected to the host device 200, the auto-run program 164, the SCSI program 165 and the widget install program 166 stored in the storage medium 160 are transmitted to the host device 200. As described above, the programs 164, 165 and 166 can be constructed as a single program and the functions of theses programs are similar to those described above with reference to the first and second embodiments. Thus, as the programs 164, 165 and 166 operate, the host device 200 is allowed to select a specific widget service and to change the relevant USB mode.

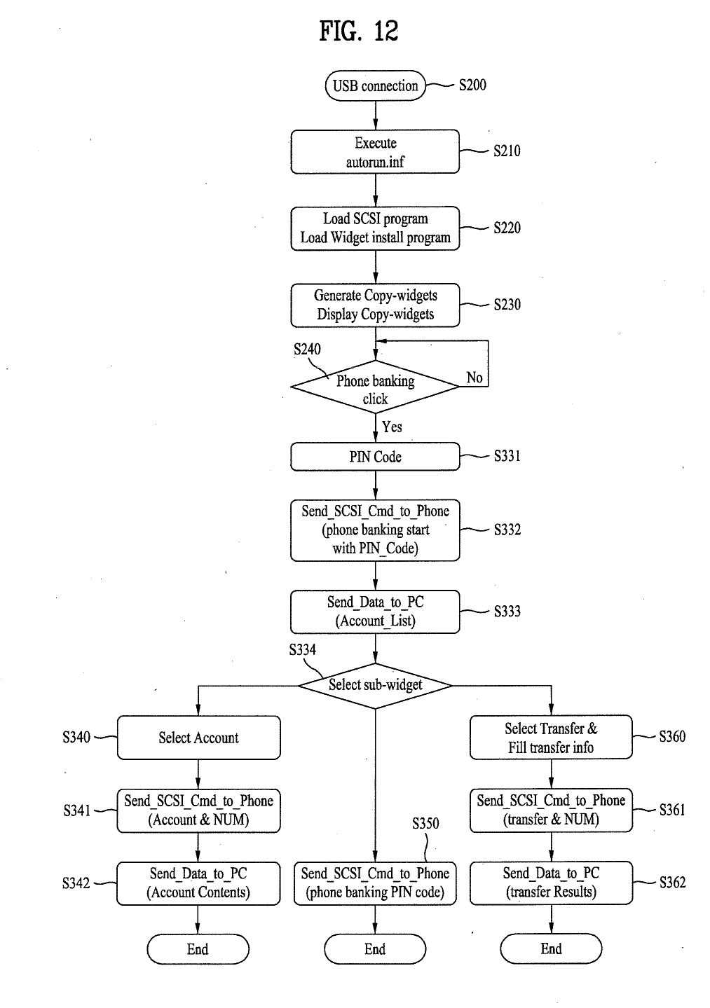

Next, FIG. 11 is a flow chart illustrating an operation of a host device according to a fourth embodiment of the present application. First, when a mobile terminal is connected to the host device (S200), an autorun file (e.g., autorun.inf) is executed in the host device (S210). Then, the autorun file loads a SCSI program, which is a USB mode change program, and a widget install program into the host device (S220).

In addition, the widget install program generates and displays copy widgets to a screen of a display of the host device (S230). Then, when the user selects a specific copy widget from the copy widgets displayed on the screen of the host device (S240), the SCSI program loaded in the host device transmits a SCSI command requesting that a currently used USB class be changed to a USB class supporting the corresponding widget to the mobile terminal (S310, S320, S330, S340 and S350). Also, the selection at step S240 can be implemented via a clicking or double clicking operation, a touch input manner, etc.

For example, when the user clicks a MP3 playback widget displayed on the screen of the host device, the host device transmits a SCSI command (MTP_Mode_Chg) requesting that the USB class be changed to a Media Transfer Protocol (MTP) class to the mobile terminal (S310). In addition, when the user clicks a DMB reception widget displayed on the screen of the host device, the host device transmits a SCSI command (UVC_Mode_Chg) requesting that the USB class be changed to a USB Video Class (UVC) to the mobile terminal (S320).

Further, when the user clicks a radio reception widget displayed on the screen of the host device, the host device transmits a SCSI command (ADC_Mode_Chg) requesting that the USB class be changed to a Audio Device Class (ADC) to the mobile terminal (S340). Also, when the user clicks a calendar widget displayed on the screen of the host device, the host device transmits a SCSI command (OBEX_Mode_Chg) requesting that the USB class be changed to a Object Exchange (OBEX) class to the mobile terminal (S350). Thus, the mobile terminal changes the currently used USB class according to the request of the SCSI command, thereby changing the USB mode to a mode capable of executing a widget desired by the user. As a result, the user can remotely execute a widget of the mobile terminal on the host device.

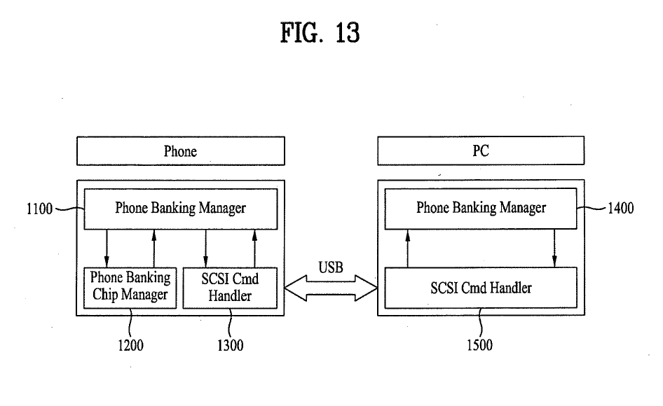

In addition, when the user clicks a phone banking widget displayed on the screen of the host device, the host device requests that the mobile terminal provide data associated with phone banking (S330). The phone banking widget will now be described in more detail with reference to FIGS. 12 and 13.

In more detail, FIG. 12 is a flow chart illustrating operations of a mobile terminal and a host device according to a fifth embodiment of the present application. That is, the flow chart of FIG. 12 illustrates a method for implementing a phone banking widget service in a host device. Thus, the fifth embodiment illustrated in FIG. 12 allows the host device to use phone banking and electronic signature functions that are embedded as secondary functions in the mobile terminal.

Further, steps S200 to S230 of FIG. 12 are similar to the steps S200 to S230 of FIG. 11. However, the step S230 includes processes for transmitting information of a phone banking widget stored in the mobile terminal to the host device and generating and displaying copy widgets of the phone banking widget based on the information of the phone banking widget at the host device. Thereafter, when the user clicks a phone banking widget in order to use the phone banking function (S240), the host device transmits a PIN code entered by the user to the mobile terminal, and the mobile terminal then activates the phone banking widget (S331, S332 and S333).

In addition, the process of step S331 is implemented in such a manner that the user enters a Personal identification Number (PIN) in the phone banking copy widget using a user input part of the host device. This process may be performed only when the phone banking copy widget is running and may be omitted for other widgets. Also, the process of step S332 is performed by a SCSI program loaded in the host device and is implemented in a manner using a specific SCSI command region as described above. More specifically, at step S332, the host device transmits a SCSI command requesting start of phone banking together with the PIN code of the user to the mobile terminal as denoted by “phone baking start with PIN_code” in FIG. 12.

At step S333, the mobile terminal transmits an account list for performing the phone banking function to the host device. This process is performed by a remotely activated phone banking widget in the mobile terminal. Also, depending on the implementation, the step S333 may be performed after step S334 taking into consideration that there is no need to display the account list in an authentication process.

At step S334, the user selects a sub-task for the phone banking copy widget on the host device. This process can be referred to as “the step of selecting a sub-widget of the copy widget”. As shown in FIG. 12, the tasks for phone banking include an account inquiry task (S340-S342), a transfer task (S360 to S362), and an electronic signature task (S350). For the account inquiry task, when the user selects an account inquiry task on the host device (S340), the host device transmits an account number (NUM) and an account inquiry command (Account) in a SCSI command format to the mobile terminal (S341). Thereafter, the mobile terminal performs account inquiry using the phone banking widget and transmits the inquired account content to the host device (S342).

For the transfer task, the user selects a transfer task on the host device and enters transfer information (S360). Then, the host device transmits an account number (NUM) and a transfer command in a SCSI command format to the mobile terminal (S361). Also, it is preferable that transfer information be transmitted together with the account number and the transfer command. Then, the mobile terminal performs a transfer using the phone banking widget and transmits the transfer result to the host device (S362).

In addition, the validity period of a certificate that the user generally uses for Internet banking on a host device is limited and thus the user must update the certificate. However, phone banking does not require such updating because the authenticity of the user is verified through a smart chip embedded in the mobile terminal. Accordingly, the illustrated phone banking and electronic signature method has an advantage that the user does not have to frequently update certificates.

Next, FIG. 13 is a block diagram of a mobile terminal 1000 and a host device 2000 for implementing the function to remotely use phone banking widgets illustrated in FIG. 12. As shown in FIG. 13, the mobile terminal 1000 includes a phone banking chip 1200, a phone banking manager 1100 and a command processor 1300.

The phone banking chip 1200 stores phone banking information of each individual, the phone banking manager 1100 provides phone banking widgets, and the command processor 1300 receives a command from the host device 2000 and transfers the command to the phone banking manager 1100. In addition, the command processor 1300 includes a SCSI framework for processing SCSI commands as in FIG. 8 described above.

Further, as shown, the host device 2000 includes a phone banking manager 2100 and a command generator 2200. The phone banking manager 2100 generates and manages copy widgets of the phone banking widgets, and the command generator 2200 generates a USB mode change command and a phone banking widget data request command and transfers the commands to the mobile terminal 1000. In addition, the command generator 2200 may include a SCSI framework for processing SCSI commands as in the second embodiment described above so that the command generator 2200 not only can generate commands but can also interpret and process commands according to the SCSI standard.

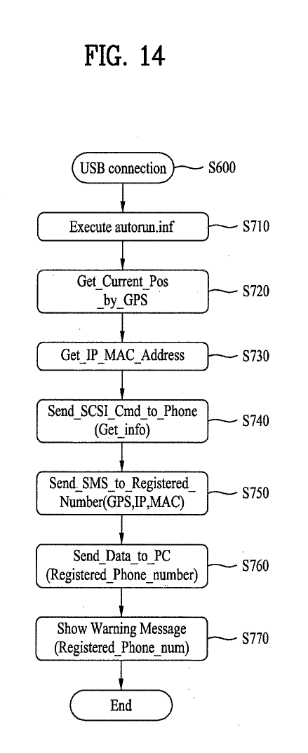

Next, FIG. 14 is a flow chart illustrating a method for using a missing guidance widget according to a sixth embodiment of the present application. In more detail, when a user reports loss of their mobile terminal to a server, a missing guidance widget in the mobile terminal is activated. Examples of activating the missing guidance widget include a activating the missing guidance widget in response to an activation instruction from a communication network for a wireless phone call of the mobile terminal, or activating the missing guidance widget when a condition according to a specific rule determined by the user is satisfied.

In more detail, the specific rule can be applied, for example in such a manner that the missing guidance widget is periodically activated when a predetermined time has elapsed and the activated missing guidance widget is deactivated when the user has entered a password or the missing guidance widget is set by default to be activated each time the mobile terminal is connected to the host device through USB.

As shown in FIG. 14, a host device and a mobile terminal are connected using a USB communication method (S600). Further, an autorun.inf file stored in the mobile terminal is loaded and executed in the host device (S710). As described above, when the autorun.inf file and the missing guidance widget operate, a USB class change program and a missing guidance program including a SCSI program are loaded in the host device.

Then, the missing guidance program reads location information of the host device (S720), and the missing guidance widget reads location information of the mobile terminal (S730). In addition, according to an instruction issued by the SCSI program (S740), the location information of the mobile terminal is transmitted to the host device (S760). A guidance message indicating that the mobile terminal is missing is then displayed on a display screen of the host device (S770).

Depending on a particular implementation, the missing guidance method can also transmit location information of the mobile terminal and/or location information of the host device to a server or perform the step S750 of transmitting location information of the mobile terminal and/or location information of the host device to a number registered in the missing guidance widget through communication means such as SMS messaging.

Therefore, the present application provides several advantageous. For example, a widget service of a mobile terminal can be viewed and modified in a host device. In addition, the user can better manage widget services on a personal computer or laptop, because the display screen is larger in size than a display screen for a mobile terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal, comprising:
an interface module configured to connect the mobile terminal to a personal computer;
a communication unit configured to communicate with the personal computer via a first communication mode; and
a controller configured to transmit an executable program to the personal computer via the interface module, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal,
wherein the communication unit is further configured to receive a modification control signal corresponding to a modification of the at least one copy widget program displayed on the personal computer, and
wherein the controller is further configured to modify the at least one original widget program on the mobile terminal with modifications made to the at least one copy widget program displayed on the personal computer.

2. The mobile terminal of claim 1, wherein the executable program transmitted to the personal computer is an auto-run program that automatically executes on the personal computer without user intervention when the mobile terminal is connected to the personal computer, and
wherein the auto-run program includes a widget install program configured to install the at least one copy widget program on the personal computer.

3. The mobile terminal of claim 1, wherein the at least one original widget program includes a plurality of original widget programs such that the executable program configured to be executed on the personal computer displays on the personal computer a plurality of copy widget programs respectively corresponding to the plurality of original widget programs executing on the mobile terminal,
wherein the communication unit is further configured to receive a selection signal from the personal computer corresponding to a selection of one of the copy widget programs displayed on the personal computer and a modification control signal corresponding to a modification of the selected one copy widget program displayed on the personal computer, and
wherein the controller is further configured to modify a corresponding original widget program on the mobile terminal with modifications made to the selected copy widget program displayed on the personal computer.

4. The mobile terminal of claim 3, wherein when the selected copy widget program utilizes a second communication mode that is different than the first communication mode being currently used to communicate between the personal computer and the mobile terminal, the communication unit is further configured to receive a mode change instruction from the personal computer instructing the mobile terminal to communicate with the personal computer via the second communication mode.

5. The mobile terminal of claim 4, wherein the communication unit is further configured to receive a communication mode change program from the personal computer via the interface module, the communication mode change program changing the first communication mode to the second communication mode.

6. The mobile terminal of claim 1, wherein the at least one original widget program corresponds to one of a multimedia widget program, a digital broadcasting widget program, a phone banking widget program, a radio widget program and a calendar widget program.

7. The mobile terminal of claim 6, wherein the second communication mode for the multimedia widget program is an Media Transfer Protocol (MTP) communication mode, the second communication mode for the digital broadcasting widget program is an Universal Serial Bus (USB) Video Class (UVC) communication mode, the second communication mode for the radio widget program is an Audio Device Class (ADC) communication mode, and the second communication mode for the calendar widget program is an (Object Exchange) OBEX communication mode.

8. A personal computer, comprising:
an interface module configured to connect the personal computer to a mobile terminal;
a communication unit configured to communicate with the mobile terminal via a first communication mode; and
a controller configured to receive an executable program from the mobile terminal via the interface module, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal,
wherein the communication unit is further configured to transmit a modification control signal corresponding to a modification of the at least one copy widget program displayed on the personal computer such that the at least one original widget program on the mobile terminal is modified with modifications made to the at least one copy widget program displayed on the personal computer.

9. The personal computer of claim 8, wherein the executable program received from the mobile terminal is an auto-run program that automatically executes on the personal computer without user intervention when the mobile terminal is connected to the personal computer, and
wherein the auto-run program includes a widget install program configured to install the at least one copy widget program on the personal computer.

10. The personal computer of claim 8, wherein the at least one original widget program includes a plurality of original widget programs such that the executable program configured to be executed on the personal computer displays on the personal computer a plurality of copy widget programs respectively corresponding to the plurality of original widget programs executing on the mobile terminal,
wherein the communication unit is further configured to transmit to the mobile terminal a selection signal corresponding to a selection of one of the copy widget programs displayed on the personal computer and a modification control signal corresponding to a modification of the selected one copy widget program displayed on the personal computer such that a corresponding original widget program on the mobile terminal is modified with modifications made to the selected copy widget program displayed on the personal computer.

11. The personal computer of claim 10, wherein when the selected copy widget program utilizes a second communication mode that is different than the first communication mode being currently used to communicate between the personal computer and the mobile terminal, the communication unit is further configured to transmit a mode change instruction to the mobile terminal instructing the mobile terminal to communicate with the personal computer via the second communication mode.

12. The personal computer of claim 11, wherein the communication unit is further configured to transmit a communication mode change program to the mobile terminal via the interface module, the communication mode change program changing the first communication mode to the second communication mode.

13. The personal computer of claim 8, wherein the at least one original widget program corresponds to one of a multimedia widget program, a digital broadcasting widget program, a phone banking widget program, a radio widget program and a calendar widget program.

14. The personal computer of claim 13, wherein the second communication mode for the multimedia widget program is an Media Transfer Protocol (MTP) communication mode, the second communication mode for the digital broadcasting widget program is an Universal Serial Bus (USB) Video Class (UVC) communication mode, the second communication mode for the radio widget program is an Audio Device Class (ADC) communication mode, and the second communication mode for the calendar widget program is an (Object Exchange) OBEX communication mode.

15. A method of communicating between a mobile terminal and a personal computer, the method comprising:
connecting the mobile terminal to the personal computer;
communicating between the personal computer and the mobile terminal using a first communication mode;
transmitting an executable program from the mobile terminal to the personal computer, the executable program configured to be executed on the personal computer and to display on the personal computer at least one copy widget program respectively corresponding to at least one original widget program executing on the mobile terminal, said at least one original widget program respectively corresponding to at least one application program controlling a respective function of the mobile terminal;
receiving on the mobile terminal from the personal computer a modification control signal corresponding to a modification of the at least one copy widget program displayed on the personal computer; and
modifying the at least one original widget program on the mobile terminal with modifications made to the at least one copy widget program displayed on the personal computer.

16. The method of claim 15, wherein the executable program transmitted to the personal computer is an auto-run program that automatically executes on the personal computer without user intervention when the mobile terminal is connected to the personal computer, and
wherein the auto-run program includes a widget install program configured to install the at least one copy widget program on the personal computer.

17. The method of claim 15, wherein the at least one original widget program includes a plurality of original widget programs such that the executable program configured to be executed on the personal computer displays on the personal computer a plurality of copy widget programs respectively corresponding to the plurality of original widget programs executing on the mobile terminal,
wherein the receiving step further comprises receiving a selection signal corresponding to a selection of one of the copy widget programs displayed on the personal computer and a modification control signal corresponding to a modification of the selected one copy widget program displayed on the personal computer, and
wherein the modifying step further comprises modifying a corresponding original widget program on the mobile terminal with modifications made to the selected copy widget program displayed on the personal computer.

18. The method of claim 17, wherein when the selected copy widget program utilizes a second communication mode that is different than the first communication mode being currently used to communicate between the personal computer and the mobile terminal, the receiving step further comprises receiving a mode change instruction from the personal computer instructing the mobile terminal to communicate with the personal computer via the second communication mode.

19. The method of claim 18, wherein the receiving step further comprises receiving a communication mode change program from the personal computer, the communication mode change program changing the first communication mode to the second communication mode.

20. The method of claim 15, wherein the at least one original widget program corresponds to one of a multimedia widget program, a digital broadcasting widget program, a phone banking widget program, a radio widget program and a calendar widget program.

21. The method of claim 20, wherein the second communication mode for the multimedia widget program is an Media Transfer Protocol (MTP) communication mode, the second communication mode for the digital broadcasting widget program is an Universal Serial Bus (USB) Video Class (UVC) communication mode, the second communication mode for the radio widget program is an Audio Device Class (ADC) communication mode, and the second communication mode for the calendar widget program is an (Object Exchange) OBEX communication mode.
